(19) United States
(12) Patent Application Publication
(10) Pub. No.: US 2007/0255660 A1
(43) Pub. Date: Nov. 1, 2007

(54) License Managing System and License Managing Method

(76) Inventor: Takanao Tanaka, Ehine (JP)

Correspondence Address: KRATZ, QUINTOS & HANSON, LLP, 1420 K Street, N.W., Suite 400, WASHINGTON, DC, 20005, US

(21) Appl. No.: 11/629,130

(22) PCT Filed: Jun. 8, 2005
(86) PCT No.: PCT/JP05/10478

§ 371 Date: May 31, 2007

(30) Foreign Application Priority Data
Jun. 11, 2004 (JP) 2004-173914

(51) Int. Cl. G06Q 99/00; G11B 20/10

(52) U.S. Cl. 705/59

(57) ABSTRACT

Data and digital contents which are normally purchased through a network are temporarily stored in a user's communication terminal such as a personal computer, information for preventing illegal copy and additional information for identifying a disk are recorded or printed on a label surface, and only when an authentication is established by a one-to-one relation of the additional information, the normally purchased data and the digital contents, the user is allowed to write the same in a writable optical disk, and the disk is licensed as a product disk. A license managing system comprises: a data sending apparatus 10 which sends content data, meta-information including an image information expressed in a visible manner, and a license recognition code; and a user terminal apparatus 20 which is connected to the data sending apparatus 10 through the Internet, and which writes the meta-information and the license recognition code sent by the data sending apparatus 10 on a label surface of an optical disk 12, and which writes the content data sent from the data sending apparatus 10 on a recording surface of the optical disk 12.

### TECHNICAL FIELD

The present invention relates to a license managing system and a license managing method for realizing whether a user terminal connected to a network (mainly, the Internet) should be allowed to write digital contents into a writable optical disk under a license using condition which defines intellectual property and using conditions. Examples of the digital contents are digital data such as data which was normally purchased by the user through the network, especially computer application software including game software, digital data such as video, animation, computer graphic, and motion capture, and digital data such as digital freeze-frame picture image such as still electrophotography, electronic music and MIDI. Examples of the writable optical disk are CD-R, CD-R/W, DVD−R, DVD−R/W, DVD+R, DVD+R/W, DVD−RAM.

### BACKGROUND TECHNIQUE

In a conventional technique, there are proposed various illegal copy preventing methods of software, but the problem of illegal copy of software still exists, and since there are loopholes for hackers and the like, software is not protected from the illegal copy under present circumstances.

Application software, audio track data of music CD, data program, general data and the like which are operated on an operation system of a recent personal computer are easily transferred through the Internet, and the current broadband Internet environment is utilized as a normal market.

However, data which is dealt on the Internet is not always normally purchased or dealt for the purpose of license.

A disk that is the same as the original can easily be formed using disk writing software, a disk having the same configuration as that of the original music CD can be formed using compressed music data such as MP3 (MPEG1 layer 3) although the sound quality is slightly deteriorated. Further, game program and a set of data are illegally distributed, and they are copied in the same or very close manner as that of the original disk.

Under the present circumstances, copyright is useless unless a complete copy preventing method of software is created. Thus, software industry receives a lot of harm.

Examples of the conventional illegal copy preventing method are as follows.

A first method uses a produce ID. According to this method, a unique product ID is recorded in a back side of a CD-ROM per one medium, and the CD-ROM is installed by precisely inputting the product ID. In a normal selling style of contents through the Internet, after the contents are downloaded, the user is informed of a product ID through electronic mail or the like. However, if someone illegally copies a CD-ROM and memorizes its product ID, and if he or she goes to another place and installs a CD-ROM which was formed through the Internet, even if this CD-ROM was illegally installed, the product ID can not be guard and the CD-ROM can be installed.

According to a second method, a hidden file is provided in a CD-ROM to guard. Ordinary persons can not see the hidden file in the CD-ROM, an attribute is recorded in the hidden file and copy is prohibited (hide “H”). If the hide “H” is converted to archive “A” (normal file), and the CD-ROM is copied and then, “A” is again converted to “H”. However, if another person notices the existence the hidden file in the file, it is easy to release the guard.

According to a third method, like the patent document 1, second managing data comprising a recording medium ID and contents ID are recorded in a recording medium in a license managing center, and the recording medium is distributed to a user, a user terminal inserts the recording medium into a recording medium inputting apparatus, accesses the license managing center through a communication network, obtains managing data including a Pay per use type license using condition, this is stored in a license using condition agreement as first managing data, and when communication between the user terminal and the license managing center can not be established, the first managing data in the license using condition agreement, the second managing data in the recording medium, and a password are checked and authenticated, and if it is authenticated, the user is allowed to continuously use the digital contents. In this method, use of illegal copy is limited. However, this method is based on the premise that the user terminal is connected to a communication network (Internet), and this method is not always suitable for use of personal computer software which need not be used in the network environment and for appreciation of picture or music.

As described above according to the conventional copy preventing method of software, the protecting means is not completed, and it is desired to propose a more convenient and complete preventing method.

[Patent document 1] Japanese Patent Application Laid-open No. 2000-90148

### DISCLOSURE OF THE INVENTION

As described above, the effect of the conventional copy preventing method is extremely low, and it is necessary to rely on legal guard under the under present circumstances. The convenience of the authentication system under the network connecting environment is deteriorated in some cases.

Hence, it is an object of the present invention to solve such conventional problems. The invention proposes that data or digital contents which are normally purchased through a network are temporarily stored in a communication terminal such as a personal computer of a user, information for preventing illegal copy or additional information for recognizing a disk is recorded or printed in a label surface, and only when an authentication is established by a one-to-one relation of the additional information and the normally purchased data or the additional information and the digital contents, the user is allowed to write the same in a writable optical disk such as CD-R, CD-R/W, DVD−R, DVD−R/W, DVD+R, DVD+R/W, DVD−RAM, and this is licensed as a product disk. A disk formed by the method of the present invention is allowed to be copied by times predetermined in the additional information, the copy right of the software is protected, and the Invention provides a license managing system and a license managing method which prevent software industry from being damaged.

A first aspect of the present invention provides a license managing system comprising: a data sending apparatus which sends content data, meta-information including an image information expressed in a visible manner, and a license recognition code; and a user terminal apparatus which is connected to the data sending apparatus through the Internet, and which writes the meta-information and the license recognition code sent by the data sending apparatus on a label surface of an optical disk, and which writes the content data sent from the data sending apparatus on a recording surface of the optical disk, wherein the user terminal apparatus comprises first storing means for storing the license recognition code concerning the content data sent from the data sending apparatus, second storing means for storing the meta-information concerning the content data, third storing means for storing the content data, optical disk writing means for writing the license recognition code stored in the first storing means on the label surface of the optical disk, optical disk reading means for reading the license recognition code written on the label surface of the optical disk, fourth storing means for storing the license recognition code which was read by the optical disk reading means, license recognition code comparing means for comparing the license recognition code stored in the first storing means and the license recognition code stored in the fourth storing means, and optical disk writing means which writes the content data stored in the third storing means on the recording surface of the optical disk when the license recognition codes match with each other in the license recognition code comparing means.

According to the first aspect, the license recognition code is written on the label surface of the optical disk and then read out and stored in the fourth storing means. This license recognition code is compared with another license recognition code stored in the first storing means with each other, thereby authenticating the license identification code. Therefore, it is possible to prevent illegal copy and to reduce the operation load of a user.

A second aspect of the invention provides a license managing system comprising: a data sending apparatus which sends content data, meta-information including an image information expressed in a visible manner, and a license recognition code; and a user terminal apparatus which is connected to the data sending apparatus through the Internet, and which writes the meta-information and the license recognition code sent by the data sending apparatus on a label surface of an optical disk, and which writes the content data sent from the data sending apparatus on a recording surface of the optical disk, wherein the user terminal apparatus comprises first storing means for storing the license recognition code concerning the content data sent from the data sending apparatus, second storing means for storing the meta-information concerning the content data, third storing means for storing the content data, means for instructing optical disk writing means to write the license recognition code stored in the first storing means on the label surface of the optical disk, means for instructing optical disk reading means to read the license recognition code written on the label surface of the optical disk, fourth storing means for storing the license recognition code which was read by the optical disk reading means, license recognition code comparing means for comparing the license recognition code stored in the first storing means and the license recognition code stored in the fourth storing means, and means for instructing optical disk writing means to write the content data stored in the third storing means on the recording surface of the optical disk when the license recognition codes match with each other in the license recognition code comparing means.

According to the second aspect, even when the user terminal apparatus does not have the optical disk writing means or the optical disk reading means, i.e., even when a so-called external record/playback apparatus is used, the license recognition code is written on the label surface of the optical disk and then read out and stored in the fourth storing means. This license recognition code is compared with another license recognition code stored in the first storing means with each other, thereby authenticating the license identification code. Therefore, it is possible to prevent illegal copy and to reduce the operation load of a user.

According to a third aspect of the invention, in the license managing system of the first or second aspect, the user terminal apparatus includes a display apparatus.

According to this aspect, the convenience of operation of a user can be enhanced.

According to a fourth aspect of the invention, in the license managing system of the first or second aspect, a microcapsule which is destroyed by temperature of laser beam and is colored is applied to the label surface of the optical disk.

According to the this aspect, the image information can be expressed in a visible manner utilizing laser beam used for recording on or replaying from the recording surface.

According to a fifth aspect of the invention, in the license managing system of the first or second aspect, when the code is written on the label surface of the optical disk, a depth of focus of laser pickup in the optical disk writing means is set to a surface of the optical disk to achieve focus.

According to this aspect, the image information can be displayed on the label surface of the optical disk.

According to a sixth aspect of the invention, in the license managing system of the first or second aspect, the meta-information stored in the second storing means is written on the label surface of the optical disk.

According to this aspect, the image information can be displayed on the label surface of the optical disk.

According to a seventh aspect of the invention, in the license managing system of the first or second aspect, the license recognition code stored in the first storing means is enciphered, the license managing system includes fifth storing means which decodes and stores the license recognition code stored in the first storing means, and in the license recognition code comparing means, the license recognition code stored in the fifth storing means and the license recognition code stored in the fourth storing means are compared with each other.

According to this aspect, the security can be enhanced.

According to an eighth aspect of the invention, in the license managing system of the first or second aspect, the license identification code written on the label surface of the optical disk is enciphered, and the license recognition code read by the optical disk reading means is decoded and stored in the fourth storing means.

According to this aspect, the security can further be enhanced.

A ninth aspect of the invention provides a license managing method comprising: a data sending apparatus which sends content data, meta-information including a visually expressed image information, and a license recognition code; and a user terminal apparatus which is connected to the data sending apparatus through the Internet, and which writes the meta-information and the license recognition code sent by the data sending apparatus on a label surface of an optical disk, and which writes the content data sent from the data sending apparatus on a recording surface of the optical disk, wherein the user terminal apparatus comprises first storing means for storing the license recognition code concerning the content data sent from the data sending apparatus, second storing means for storing the meta-information concerning the content data, third storing means for storing the content data, optical disk writing means for writing data on the optical disk, optical disk reading means for reading data written on the optical disk, and processing means which reads data from the first storing means, the second storing means and the third storing means, and which instructs the optical disk writing means and the optical disk reading means, and wherein the processing means comprises a step for writing the license recognition code stored in the first storing means on the label surface of the optical disk, a step for reading the license recognition code written on the label surface of the optical disk, a step for storing the license recognition code read by the optical disk reading means in the fourth storing means, a step for comparing the license recognition code stored in the first storing means and the license recognition code stored in the fourth storing means in license recognition code comparing means, and a step for writing the content data stored in the third storing means on the recording surface of the optical disk when the codes match with each other in the license recognition code comparing means.

According to this aspect, the license recognition code is written on the label surface of the optical disk and then read out and stored in the fourth storing means. This license recognition code is compared with another license recognition code stored in the first storing means with each other, thereby authenticating the license identification code. Therefore, it is possible to prevent illegal copy and to reduce the operation load of a user.

A tenth aspect of the invention provides a license managing method comprising: a data sending apparatus which sends content data, meta-information including a visually expressed image information, and a license recognition code; and a user terminal apparatus which is connected to the data sending apparatus through the Internet, and which writes the meta-information and the license recognition code sent by the data sending apparatus on a label surface of an optical disk, and which writes the content data sent from the data sending apparatus on a recording surface of the optical disk, wherein the user terminal apparatus comprises first storing means for storing the license recognition code concerning the content data sent from the data sending apparatus, second storing means for storing the meta-information concerning the content data, third storing means for storing the content data, optical disk writing means for writing data on the optical disk, optical disk reading means for reading data written on the optical disk, and processing means which reads data from the first storing means, the second storing means and the third storing means, and which instructs the optical disk writing means and the optical disk reading means, and wherein the processing means comprises a step for detecting that the label surface of the optical disk is normally set, a step for writing the license recognition code stored in the first storing means on the label surface of the optical disk when the label surface of the optical disk is normally set, a step for reading the license recognition code written on the label surface of the optical disk, a step for storing the license recognition code read by the optical disk reading means in fourth storing means, a step for detecting that a recording surface of the optical disk is normally set, a step for comparing the license recognition code stored in the first storing means and the license recognition code stored in the fourth storing means in license recognition code comparing means when the recording surface of the optical disk is normally set, and a step for writing the content data stored in the third storing means on the recording surface of the optical disk when the codes match with each other in the license recognition code comparing means.

According to this aspect, the license recognition code is written on the label surface of the optical disk and then read out and stored in the fourth storing means. This license recognition code is compared with another license recognition code stored in the first storing means with each other, thereby authenticating the license identification code. Therefore, it is possible to prevent illegal copy and to reduce the operation load of a user.

According to an eleventh aspect of the invention, in the license managing system of the ninth or tenth aspect, before the content data is written on the recording surface of the optical disk, the license identification code is renewed in succession in accordance with the number of writing operations of the license identification code, and the content data is permitted to write by predetermined times defined in the license code.

According to this aspect, a plurality of licenses can be sent at a time.

According to a twelfth aspect of the invention, in the license managing system of the ninth or tenth aspect, disk writing software is previously sent, and writing operations on the label surface and the recording surface of the optical disk are carried out using the disk writing software.

According to this aspect, a contents purchaser is allowed to write on the label surface and the recording surface of the optical disk using the special disk writing software. Therefore, it is possible to further prevent illegal copy and it becomes easy to operate.

According to the present invention, it is possible to prevent illegal copy of downloaded digital content data, and to lighten an operation load of a user.

### BRIEF DESCRIPTION OF THE DRAWINGS

FIG. 1 is a block diagram of a license managing system according to an embodiment by way of function realizing means;

FIG. 2 is a flowchart showing a flow of the license managing system of the embodiment;

FIG. 3 is a flowchart showing the flow of the license managing system of the embodiment;

FIG. 4 is a configuration diagram showing a label surface of an optical disk shown by the embodiment; and

FIG. 5 is another configuration diagram showing a label surface of an optical disk shown by the embodiment.

### BEST MODE FOR CARRYING OUT THE INVENTION

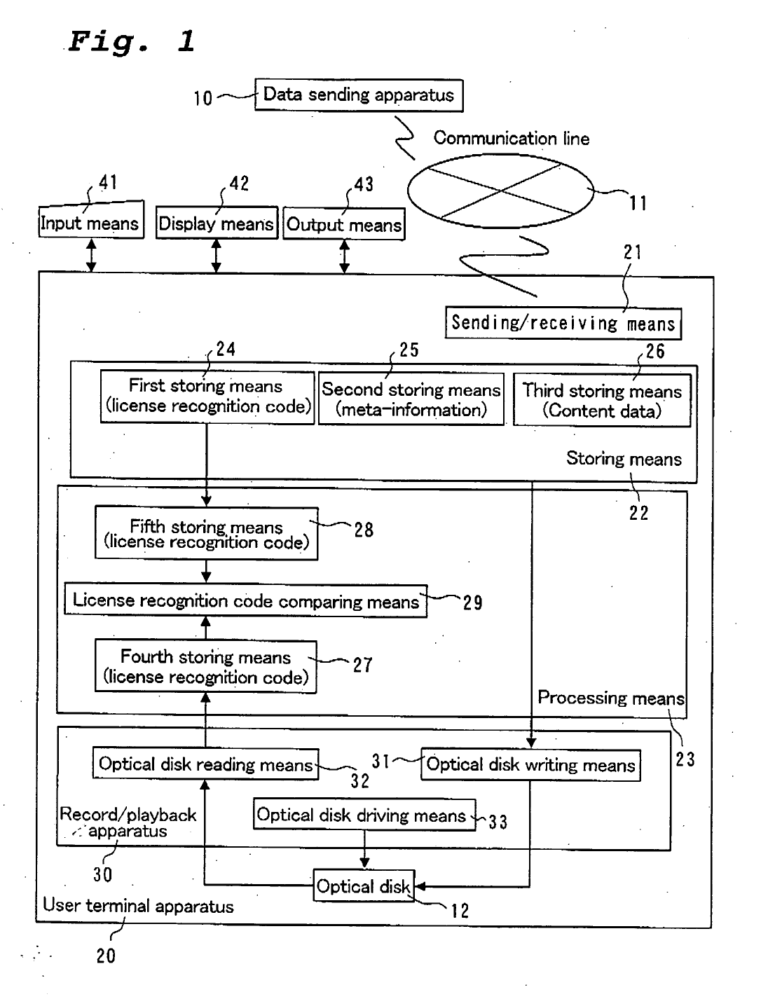

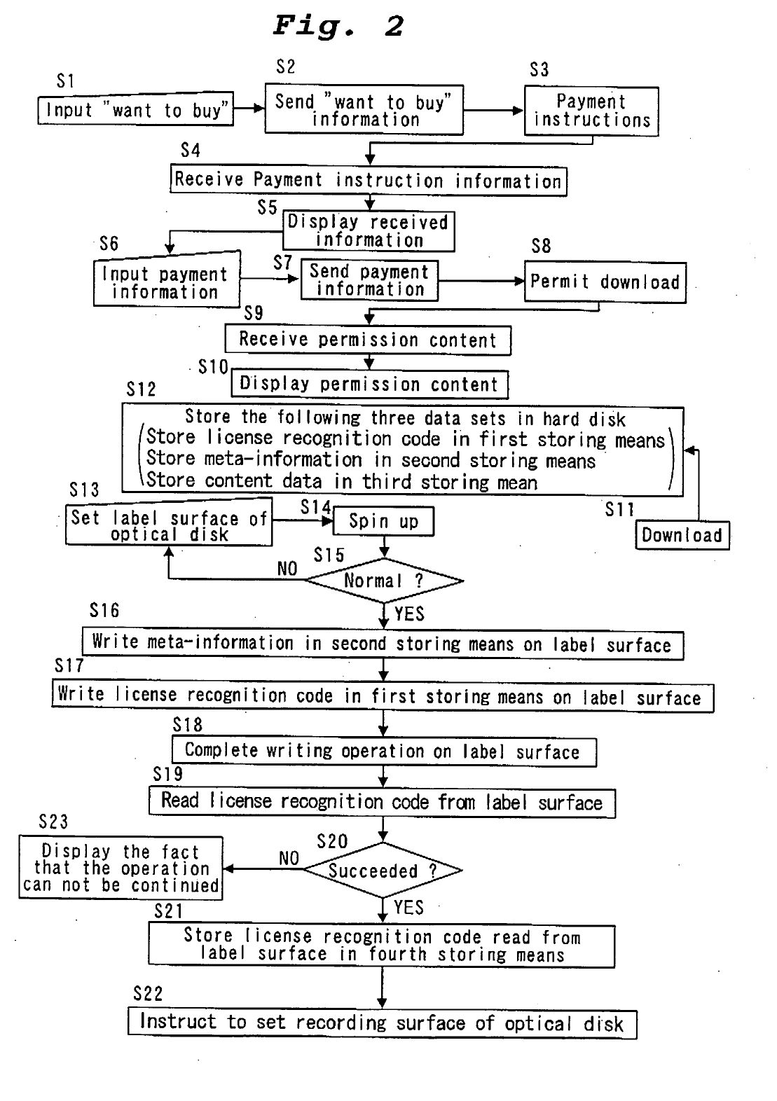

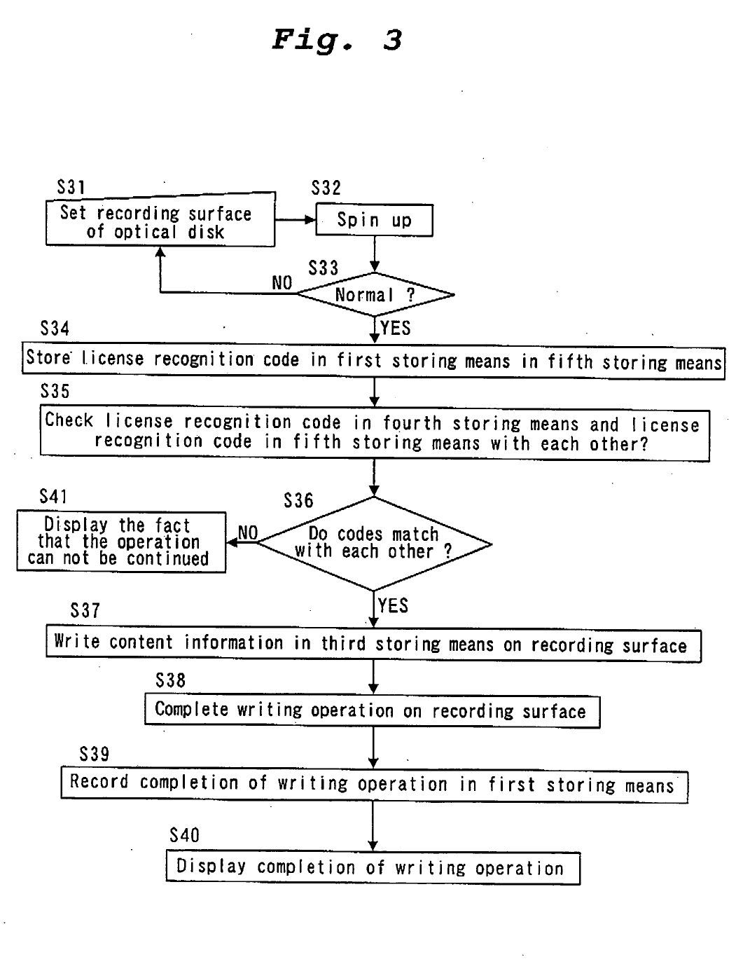

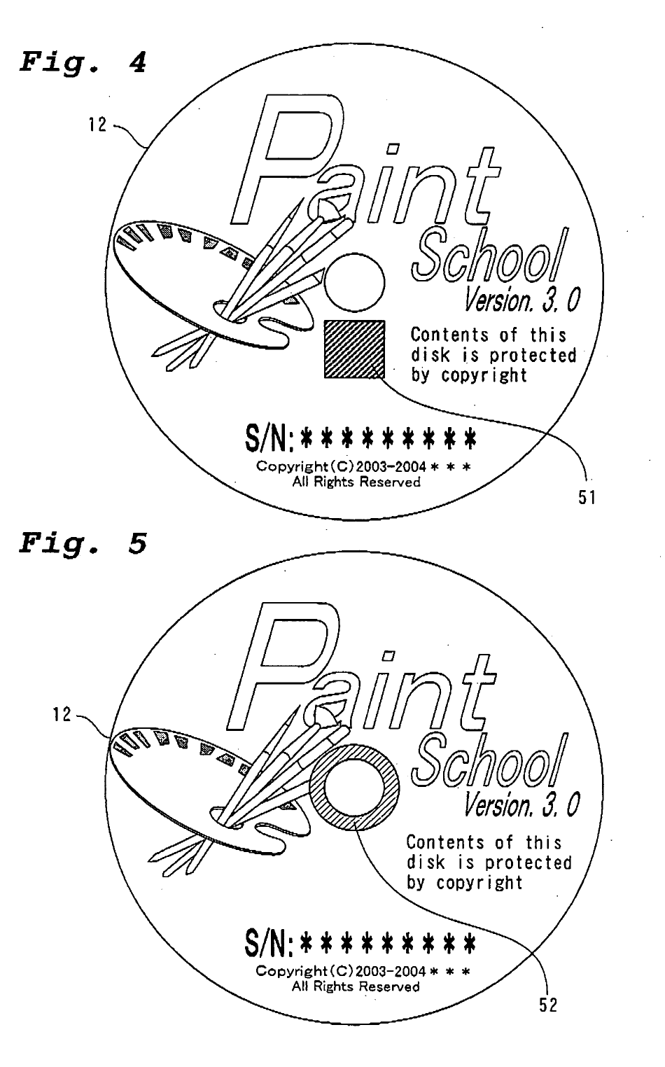

An embodiment of a license managing system of the present invention will be explained with reference to the drawings. FIG. 1 is a block diagram of a license managing system according to the embodiment by way of function realizing means. FIGS. 2 and 3 are flowcharts showing a flow of the license managing system of the embodiment. FIG. 4 is a configuration diagram showing a label surface of an optical disk shown by the embodiment.

First, necessary functions for realizing the license managing system of the embodiment will be explained.

The license managing system of the embodiment includes a data sending apparatus 10 for sending content data, meta-information including image information which is expressed in a visible manner, and a license recognition code. The license managing system also includes a user terminal apparatus 20 connected to the data sending apparatus 10 through a communication line 11 such as the Internet. The user terminal apparatus 20 writes the meta-information sent from the data sending apparatus 10 and the license recognition code into a label surface of an optical disk 12, and writes the content data sent from the data sending apparatus 10 into the recording surface of the optical disk 12.

Here, content data sent from the data sending apparatus 10 includes computer application software including game software, digital data such as video including movie, animation, computer graphic, and motion capture, and digital data such as digital freeze-frame picture image data such as still electrophotography, electronic music, and MIDI. The meta-information sent from the data sending apparatus 10 includes title, composer, owner of copyright, second owner of copyright, publisher, outline, and image information expressing contents of output or program concerning the sent content data in a visible manner. It is preferable that the license recognition code sent from the data sending apparatus 10 is enciphered like a group of image or characters which is scrambled in an encipher mode which is inherent in a sender of the contents corresponding to one-dimensional or two-dimensional bar code or writer software provided by the sender of the contents.

The optical disk 12 is a medium such as CD-R, CD-R/W, DVD−R, DVD−R/W, DVD+R, DVD+R/W, DVD−RAM. The label surface of the optical disk 12 is formed on a surface of a writable optical disk medium opposite from a recording surface on which content data is to be recorded.

The user terminal apparatus 20 includes sending/receiving means 21 which sends and receives data to and from the data sending apparatus 10, storing means 22 which stores information received by the sending/receiving means 21, record/playback apparatus 30 which writes data into the optical disk 12 and reads data from the optical disk 12, and processing means 23 which reads data from the storing means 22 and gives instructions to the record/playback apparatus 30. Here, the record/playback apparatus 30 need not be provided in the user terminal apparatus 20, and may be a so-called external record/playback apparatus.

The storing means 22 includes first storing means 24 for storing license recognition code concerning content data received by the sending/receiving means 21, second storing means 25 for storing meta-information concerning the content data, and third storing means 26 for storing content data. These first storing means 24, second storing means 25 and third storing means 26 need not be separate storing means in terms of hardware.

The record/playback apparatus 30 includes optical disk writing means 31 for writing data on a label surface or recording surface of the optical disk 12, optical disk reading means 32 for reading data written on the label surface or recording surface of the optical disk 12, and optical disk driving means 33 for rotating the optical disk 12. In this embodiment, the optical disk writing means 31 which writes data on the label surface of the optical disk 12 and the optical disk writing means 31 which writes data on the recording surface of the optical disk 12 are explained as being one means, but they may be separate means. Similarly, the optical disk reading means 32 which reads data written on the label surface of the optical disk 12 and the optical disk reading means 32 which reads data written on the recording surface of the optical disk 12 are explained as being one means, but they may be separate means.

The processing means 23 includes means for instructing the optical disk writing means 31 to write a license recognition code stored in the first storing means 24 on the label surface of the optical disk 12, means for instructing the optical disk reading means 32 to read the license recognition code written on the label surface of the optical disk 12, fourth storing means 27 for storing the license recognition code which was read by the optical disk reading means 32, fifth storing means 28 for reading and storing the license recognition code stored in the first storing means 24, license recognition code comparing means 29 for comparing the license recognition code stored in the fifth storing means 28 and the license recognition code stored in the fourth storing means 27, and means for instructing the optical disk writing means 31 to write content data stored in the third storing means 26 on the recording surface of the optical disk 12 when the codes match with each other in the license recognition code comparing means 29. In this embodiment, it is preferable that a license identification code stored in the first storing means 24 is enciphered. In the fifth storing means 28, a license recognition code stored in the first storing means 24 is decoded and stored. It is preferable that a license identification code written on the label surface of the optical disk 12 is also enciphered. In the fourth storing means 27, a license recognition code read by the optical disk reading means 32 is decoded and stored.

The user terminal apparatus 20 includes Input means 41 for inputting data, display means 42 for displaying information and output means 43 such as a printer.

Next, a flow of processing in the license managing system of the embodiment will be explained.

First, a user inputs “want to buy” of digital contents by means of the input means 41 (S1). This input data is sent from the sending/receiving means 21 (S2), the sent desired information is received by a system on the side of the data sending apparatus 10 through the communication line 11. The system on the side of the data sending apparatus 10 sends instructions of payment (S3), and this data is received by the sending/receiving means 21 as payment instruction information (S4). The reception information is displayed on the display means 42 (S5), and the user inputs payment information from the input means 41 (S6). This payment data is sent from the sending/receiving means 21 (S7), the sent payment information is received by the system on the side of the data sending apparatus 10 through the communication line 11. If the payment information is confirmed, permission information of download is sent from the system on the side of the data sending apparatus 10 (S8), this data is received by the sending/receiving means 21 as permission information (S9), and this is displayed on the display means 42 (S10). The data sending apparatus 10 sends data (S11), and this data is downloaded to the storing means 22 (S12). In step 12, a license recognition code concerning content data is stored in the first storing means 24, meta-information concerning content data is stored in the second storing means 25, and content data is stored in the third storing means 26.

If the download by the user terminal apparatus 20 is completed, a user sets a label surface of the optical disk 12 on the record/playback apparatus 20 (S13). The optical disk 12 is spun up by the optical disk driving means 33 (S14), and data is read from the optical disk 12 by the optical disk reading means 32, thereby determining whether the optical disk 12 is normally set (S11). If the optical disk 12 is not normally set, the user is encouraged to set the optical disk 12 again, and if the label surface of the optical disk 12 is normally set, meta-information stored in the second storing means 25 is written on the label surface of the optical disk 12 (S16), and the license recognition code stored in the first storing means 24 is written on the label surface of the optical disk 12 (S17), and the writing operation on the label surface of the optical disk 12 is completed (S18). Then, the license recognition code written on the label surface of the optical disk 12 is read (S19), it is determined whether the computer succeeded the reading operation of the optical disk reading means 32 (S20), and if the computer could not read or the read data does not match, the fact that the operation can not be continued is displayed on the display means 42 (S23). If the computer succeeded the reading operation of the optical disk reading means 32 in step 20, the license recognition code read by the optical disk reading means 32 is stored in the fourth storing means (S21), and the display means 42 shows the user instructions to set the recording surface of the optical disk 12 on the record/playback apparatus 30 (S22).

The user sets the recording surface of the optical disk 12 on the record/playback apparatus 20 (S31). The optical disk 12 is spun up by the optical disk driving means 33 (S32), and data is read from the optical disk 12 by the optical disk reading means 32, thereby determining whether the optical disk 12 is normally set (S33). If the optical disk 12 is not normally set, the user is encouraged to set the optical disk 12 again, and if the recording surface of the optical disk 12 is normally set, the license recognition code stored in the first storing means 24 is stored in the fifth storing means 28 (S34), and the license recognition code stored in the fifth storing means 28 and the license recognition code stored in the fourth storing means 27 are checked with each other by the license recognition code comparing means 29 (S35). As a result of the check, if these codes do not match with each other in the license recognition code comparing means 29, the fact that writing is not permitted is displayed (S41), and if the codes match with each other, content data stored in the third storing means 26 is written on the recording surface of the optical disk 12 (S37), and the writing operation on the recording surface is completed (S38). The completion of the writing operation is recorded in the first storing means 24 (S39), and the completion of the writing operation is displayed on the display means 42 (S40).

FIG. 4 shows a state in which the data is recorded in the label surface of the optical disk 12.

As shown in FIG. 4, a title “Paint School Version 3.0” concerning content data written on the recording surface and other meta-information are shown in a visible manner. Further, a two-dimensional bar code is shown on a portion of the label surface as a license recognition code 51.

FIG. 5 shows another configuration showing a label surface of the optical disk shown by the embodiment.

A one-dimensional bar code is shown around a center hole of the optical disk 12 as a license recognition code 52.

Although the license recognition code is one-dimensional or two-dimensional bar code in the embodiment, the license recognition code may be a code having a unique encipher rule.

If a microcapsule which is destroyed by the temperature of laser beams and is colored is applied to a label surface as the optical disk 12, image information can be expressed in a visible manner utilizing laser beams which are used for recording and replaying with respect to the recording surface of the optical disk 12.

When digital data is written on the label surface of the optical disk 12, the depth of focus of laser pickup in the optical disk writing means 31 is set to the surface of the optical disk 12 to achieve the focus.

Although the license recognition code concerning content data and meta-information concerning content data are stored in different storing means 24 and 25, respectively in the embodiment, license code may be embedded in the meta-information and sent, and they may be printed at the same time. It is not always necessary to print the meta-information.

It is preferable that the license identification code is renewed in succession in accordance with the number of writing operations of the license identification code and the writing operations by the predetermined times stored in the license code are permitted ,before writing content data on the recording surface of the optical disk 12. A plurality of licenses can be sent at a time.

It is preferable that disk writing software is previously sent before step 11 of this embodiment, and codes are written on the label surface and the recording surface of the optical disk 12 using the disk writing software. If a purchaser of the contents is allowed to use the special disk writing software to write the codes on the label surface and the recording surface of the optical disk 12, it is possible to further prevent the illegal copy, and the user can easily operate. If the purchaser is previously provided with application software including special content download function together with the special disk writing software, the inconvenience of the user is enhanced, and the security is improved.

As described above, the present invention is suitable for a license managing system and a license managing method for realizing whether a user terminal connected to a network should be allowed to write digital contents into an optical disk under a license using condition which defines intellectual property and using conditions. Examples of the digital contents are digital data such as data which was normally purchased by the user through the network, especially computer application software including game software, video, animation, computer graphic, motion capture, and digital data such as still electrophotography, electronic music and MIDI.

1. A license managing system comprising: a data sending apparatus which sends content data, meta-information including an image information expressed in a visible manner, and a license recognition code; and a user terminal apparatus which is connected to said data sending apparatus through the Internet, and which writes the met a-information and the license recognition code sent by said data sending apparatus on a label surface of an optical disk, and which writes the content data sent from the data sending apparatus on a recording surface of said optical disk, wherein
said user terminal apparatus comprises
first storing means for storing the license recognition code concerning the content data sent from said data sending apparatus,
second storing means for storing the met a-information concerning the content data,
third storing means for storing the content data,
optical disk writing means for writing the license recognition code stored in said first storing means on the label surface of said optical disk,
optical disk reading means for reading the license recognition code written on the label surface of said optical disk,
fourth storing means for storing the license recognition code which was read by said optical disk reading means,
license recognition code comparing means for comparing the license recognition code stored in said first storing means and the license recognition code stored in said fourth storing means, and
optical disk writing means which writes the content data stored in said third storing means on the recording surface of said optical disk when the license recognition codes match with each other in said license recognition code comparing means.

2. A license managing system comprising: a data sending apparatus which sends content data, meta-information including an image information expressed in a visible manner, and a license recognition code; and a user terminal apparatus which is connected to said data sending apparatus through the Internet, and which writes the meta-information and the license recognition code sent by said data sending apparatus on a label surface of an optical disk, and which writes the content data sent from the data sending apparatus on a recording surface of said optical disk, wherein
said user terminal apparatus comprises
first storing means for storing the license recognition code concerning the content data sent from said data sending apparatus,
second storing means for storing the meta-information concerning the content data,
third storing means for storing the content data,
means for instructing optical disk writing means to write the license recognition code stored in said first storing means on the label surface of said optical disk,
means for instructing optical disk reading means to read the license recognition code written on the label surface of said optical disk,
fourth storing means for storing the license recognition code which was read by said optical disk reading means,
license recognition code comparing means for comparing the license recognition code stored in said first storing means and the license recognition code stored in said fourth storing means, and
means for instructing optical disk writing means to write the content data stored in said third storing means on the recording surface of said optical disk when the license recognition codes match with each other in said license recognition code comparing means.

3. The license managing system according to claim 1, wherein the user terminal apparatus includes a display apparatus.

4. The license managing system according to claim 1, wherein a microcapsule which is destroyed by temperature of laser beam and is colored is applied to the label surface of said optical disk.

5. The license managing system according to claim 1, wherein when the code is written on the label surface of said optical disk, a depth of focus of laser pickup in said optical disk writing means is set to a surface of said optical disk to achieve focus.

6. The license managing system according to claim 1, wherein the met a-information stored in said second storing means is written on the label surface of said optical disk.

7. The license managing system according to claim 1, wherein the license recognition code stored in said first storing means is enciphered, said license managing system includes fifth storing means which decodes and stores the license recognition code stored in said first storing means, and in said license recognition code comparing means, the license recognition code stored in the fifth storing means and the license recognition code stored in said fourth storing means are compared with each other.

8. The license managing system according to claim 1, wherein the license identification code written on the label surface of said optical disk is enciphered, and the license recognition code read by said optical disk reading means is decoded and stored in said fourth storing means.

9. A license managing method comprising: a data sending apparatus which, sends content data, meta-information including an image information expressed in a visible manner, and a license recognition code; and a user terminal apparatus which is connected to said data sending apparatus through the Internet, and which writes the meta-information and the license recognition code sent by said data sending apparatus on a label surface of an optical disk, and which writes the content data sent from the data sending apparatus on a recording surface of said optical disk, wherein
said user terminal apparatus comprises
first storing means for storing the license recognition code concerning the content data sent from said data sending apparatus,
second storing means for storing the meta-information concerning the content data,
third storing means for storing the content data,
optical disk writing means for writing data on said optical disk,
optical disk reading means for reading data written on said optical disk, and
processing means which reads data from said first storing means, said second storing means and said third storing means, and which instructs said optical disk writing means and said optical disk reading means, and wherein
said processing means comprises
a step for writing the license recognition code stored in said first storing means on the label surface of said optical disk,
a step for reading the license recognition code written on the label surface of said optical disk,
a step for storing the license recognition code read by said optical disk reading means in said fourth storing means,
a step for comparing the license recognition code stored in said first storing means and the license recognition code stored in said fourth storing means in license recognition code comparing means, and
a step for writing the content data stored in said third storing means on the recording surface of said optical disk when the codes match with each other in said license recognition code comparing means.

10. A license managing method comprising: a data sending apparatus which sends content data, meta-information including an image information expressed in a visible manner, and a license recognition code; and a user terminal apparatus which is connected to said data sending apparatus through the Internet, and which writes the met a-information and the license recognition code sent by said data sending apparatus on a label surface of an optical disk, and which writes the content data sent from the data sending apparatus on a recording surface of said optical disk, wherein
said user terminal apparatus comprises
first storing means for storing the license recognition code concerning the content data sent from said data sending apparatus,
second storing means for storing the meta- information concerning the content data,
third storing means for storing the content data,
optical disk writing means for writing data on said optical disk,
optical disk reading means for reading data written on said optical disk, and
processing means which reads data from said first storing means, said second storing means and said third storing means, and which instructs said optical disk writing means and said optical disk reading means, and wherein
said processing means comprises
a step for detecting that the label surface of said optical disk, is normally set,
a step for writing the license recognition code stored in said first storing means on the label surface of said optical disk when the label surface of said optical disk is normally set,
a step for reading the license recognition code written on the label surface of said optical disk,
a step for storing the license recognition code read by said optical disk reading means in fourth storing means,
a step for detecting that a recording surface of said optical disk is normally set,
a step for comparing the license recognition code stored in said first storing means and the license recognition code stored in said fourth storing means in license recognition code comparing means when the recording surface of said optical disk is normally set, and
a step for writing the content data stored in said third storing means on the recording surface of said optical disk when the codes match with each other in said license recognition code comparing means.

11. The license managing method according to claim 9, wherein before the content data is written on the recording surface of said optical disk, the license identification code is renewed in succession in accordance with the number of writing operations of the license identification code, and the content data is permitted to write by predetermined times defined in the license code.

12. The license managing method according to claim 9, wherein disk writing software is previously sent, and writing operations on the label surface and the recording surf ace of said optical disk are carried out using the disk writing software.

13. The license managing system according to claim 2, wherein the user terminal apparatus includes a display apparatus.

14. The license managing system according to claim 2, wherein a microcapsule which is destroyed by temperature of laser beam and is colored is applied to the label surface of said optical disk.

15. The license managing system according to claim 2, wherein when the code is written on the label surface of said optical disk, a depth of focus of laser pickup in said optical disk writing means is set to a surface of said optical disk to achieve focus.

16. The license managing system according to claim 2, wherein the met a-information stored in said second storing means is written on the label surface of said optical disk.

17. The license managing system according to claim 2, wherein the license recognition code stored in said first storing means is enciphered, said license managing system includes fifth storing means which decodes and stores the license recognition code stored in said first storing means, and in said license recognition code comparing means, the license recognition code stored in the fifth storing means and the license recognition code stored in said fourth storing means are compared with each other.

18. The license managing system according to claim 2, wherein the license identification code written on the label surface of said optical disk is enciphered, and the license recognition code read by said optical disk reading means is decoded and stored in said fourth storing means.

19. The license managing method according to claim 10, wherein before the content data is written on the recording surface of said optical disk, the license identification code is renewed in succession in accordance with the number of writing operations of the license identification code, and the content data is permitted to write by predetermined times defined in the license code.

20. The license managing method according to claim 10, wherein disk writing software is previously sent, and writing operations on the label surface and the recording surf ace of said optical disk are carried out using the disk writing software.
